(19) United States
(12) Patent Application Publication
(10) Pub. No.: US 2021/0202947 A1
(43) Pub. Date: Jul. 1, 2021

(54) METHODS FOR PRODUCING OF COATED POSITIVE ELECTRODE ACTIVE MATERIAL AND LITHIUM-ION SECONDARY BATTERY AND LITHIUM-ION SECONDARY BATTERY

(71) Applicants: KANEKA CORPORATION, Osaka (JP); OSAKA UNIVERSITY, Osaka (JP)

(72) Inventors: Takashi Kikuchi, Osaka (JP); Kohei Ogawa, Osaka (JP); Kazuaki Kanai, Osaka (JP); Makio Naito, Osaka (JP); Takahiro Kozawa, Osaka (JP)

(73) Assignees: KANEKA CORPORATION, Osaka (JP); OSAKA UNIVERSITY, Osaka (JP)

(21) Appl. No.: 17/192,975

(22) Filed: Mar. 5, 2021

Related U.S. Application Data
(63) Continuation of application No. PCT/JP2019/025451, filed on Jun. 26, 2019.

(30) Foreign Application Priority Data
Sep. 7, 2018 (JP) 2018-167978

(51) Int. Cl. H01M 4/62; H01M 4/525; H01M 4/505; H01M 4/04; H01M 10/0525; H01M 4/36; C01G 53/00

(52) U.S. Cl. CPC H01M 4/62; H01M 4/525; H01M 4/505; H01M 2004/028; H01M 10/0525; H01M 4/366; C01G 53/54; H01M 4/0402

(57) ABSTRACT

A method for producing a positive electrode active material is provided. The method can prevent a gas generation due to an oxidative degradation of a non-aqueous electrolyte in a lithium-ion secondary battery using a positive electrode active material which operates at a high potential. A method for producing a coated positive electrode active material for a lithium-ion secondary battery includes coating a surface of a positive electrode active material with an oxide-based solid electrolyte by a mechanical coating method and then conducting heat treatment at 300° C. or higher, and the positive electrode active material has an average potential of extraction and insertion of lithium of 4.5V or more and 5.0V or less based on Li⁺/Li.

### CROSS REFERENCE TO RELATED APPLICATIONS

The present application claims the benefits of the priority of Japanese Patent Application No. 2018-167978 filed on Sep. 7, 2018. The entire contents of the specification of Japanese Patent Application No. 2018-167978 filed on Sep. 7, 2018 are incorporated by reference herein.

### TECHNICAL FIELD

Embodiments in accordance with the present disclosure relate to a method for producing a coated positive electrode active material for a lithium-ion secondary battery and more specifically relates to a method for producing a coated positive electrode active material which is used for a lithium-ion secondary battery and reduces generation of gas during the operation at a high potential.

### BACKGROUND

Lithium-ion secondary batteries are studied and developed extensively for the applications for mobile devices, hybrid vehicles, electric cars and household storage batteries. Lithium-ion secondary batteries used in the fields are required to be highly safe and have long-term cycle stability, a high energy density and the like.

Recently, lithium-ion secondary batteries using lithium titanate as a negative electrode active material have been proposed in view of the high safety and the long-term cycle stability. Because the operation potential of lithium titanate is higher than that of graphite or the like, which is a general negative electrode active material, lithium does not easily precipitate, and the safety improves. However, lithium titanate has a disadvantage in terms of the energy density.

Regarding the positive electrode active material, a material which operates at a high potential of 4.5 V or more based on the precipitation potential of Li has been proposed (for example, PTL 1).

### PATENT LITERATURE

PTL 1: JP-A-2001-185148

It is expected that a decrease in the energy density caused by a high operation potential of lithium titanate is reduced by combining the positive electrode active material which operates at a high potential described in PTL 1 above and lithium titanate. Here, in a conventional lithium-ion secondary batteries using graphite as the negative electrode active material, gas is generated due to an oxidative degradation of a non-aqueous electrolyte on a surface of a positive electrode active material, and gas generation becomes more considerable in the case of a secondary battery in which an operation potential of a positive electrode active material is higher than those of the conventional secondary batteries.

A means of forming a coating on the surface of the positive electrode by adding an additive to the non-aqueous electrolyte and thus preventing the gas generation is also employed for the conventional lithium-ion secondary batteries. Although a similar principle can be applied also to a high potential positive electrode active material, the coating is required to have higher oxidation resistance, and thus it is believed that the effects are not sufficient.

### SUMMARY

A method is provided for producing a positive electrode active material which can prevent the gas generation due to the oxidative degradation of the non-aqueous electrolyte in a lithium-ion secondary battery using a positive electrode active material which operates at a high potential.

In view of the above circumstances, the present inventors have considered the means for preventing the gas generation and, as a result, have succeeded by coating a surface of a positive electrode active material which operates at a high potential with a solid electrolyte by a mechanical coating method. The invention has been thus completed.

One or more embodiments of the present disclosure are as follows. [1] A method for producing a coated positive electrode active material for a lithium-ion secondary battery, the method comprising:

coating a surface of a positive electrode active material with an oxide-based solid electrolyte by a mechanical coating method and then conducting heat treatment at 300° C. or higher, wherein the positive electrode active material has an average potential of extraction and insertion of lithium of 4.5V or more and 5.0V or less based on Li⁺/Li. [2] The method according to [1], wherein a ratio of a median diameter of the positive electrode active material to a diameter determined from a BET specific surface area of the oxide-based solid electrolyte is 10000:1 to 100:1. [3] The method according to [1] or [2], wherein the mechanical coating is conducted with a grinding mill. [4] The method according to any one of [1] to [3], wherein the positive electrode active material is a substituted lithium manganese compound represented by formula (1) below:

Li₁₊ₓM_{y}Mn_{2-x-y}O₄ (1)

wherein in formula (1), x and y satisfy 0≤x≤0.2 and 0<y≤0.8, respectively, and M is at least one kind selected from the group consisting of Al, Mg, Zn, Ni, Co, Fe, Ti, Cu and Cr.

[5] A method for producing a lithium-ion secondary battery having a positive electrode, a negative electrode and a non-aqueous electrolyte, the method comprising:

a step of applying a positive electrode mixture containing the coated positive electrode active material obtained by the method according to any one of [1] to [4] to a positive electrode current collector.

[6] A lithium-ion secondary battery obtained by the method according to [5].

According to one or more embodiments of the present disclosure, a positive electrode active material which operates at a high potential and which can prevent a gas generation due to an oxidative degradation of a non-aqueous electrolyte can be produced.

### DETAILED DESCRIPTION

Although embodiments of the present disclosure are explained below, the disclosure is not limited to the embodiments.

The producing method of one or more embodiments of the present disclosure is characterized by coating a surface of a positive electrode active material which operates at a high potential with an oxide-based solid electrolyte by a mechanical coating method and further conducting heat treatment at 300° C. or higher.

In general, a non-aqueous electrolyte is used for a lithium-ion secondary battery, and a non-aqueous electrolyte in a liquid state obtained by dissolving a lithium salt in a non-aqueous solvent is used, although the details will be described below. Here, there is a solid electrolyte in a solid state which has functions of both of the non-aqueous solvent and the lithium salt. The solid electrolyte has higher oxidation resistance than the non-aqueous electrolyte in a liquid state, and thus the oxidative degradation at a high potential can be prevented. However, because the lithium-ion conductivity of a solid is lower than that of a liquid, the performance as a battery deteriorates greatly when the whole electrolyte is replaced with the solid electrolyte.

Therefore, by mechanically coating only a surface of a high potential positive electrode active material with the solid electrolyte, the gas generation can be prevented even using the conventional non-aqueous electrolyte. Because the solid electrolyte is in a solid state, enormous energy of a certain level is required to coat a solid positive electrode active material. Accordingly, a mechanical coating method which can apply shearing force and compressive force is preferable. By coating the positive electrode active material with the solid electrolyte, the contact between the conventional non-aqueous electrolyte and the positive electrode active material can be reduced, and the gas generation can be prevented. Moreover, although the details will be described below, by adjusting the heat treatment temperature and by controlling the particle size of the solid electrolyte or the mixing ratio of the solid electrolyte to the positive electrode active material, the positive electrode active material can be coated with the solid electrolyte without increasing the resistance of the positive electrode active material and without deteriorating the battery performance.

### <Mechanical Coating Method>

The mechanical coating refers to a means which applies at least one kind of energy of shearing force, compressive force, impact force and centrifugal force to a base material and/or a coating agent (preferably can apply shearing force and compressive force, more preferably can apply shearing force, compressive force and impact force) and which at the same time mixes the base material and the coating agent and coats the surface of the base material with the coating material by mechanically bringing the base material and the coating agent into contact with each other. In one or more embodiments, the positive electrode active material corresponds to the base material, and the coating agent corresponds to the oxide-based solid electrolyte. The apparatus used is not particularly limited, and for example, a grinding mill represented by Nobilta manufactured by Hosokawa Micron Corporation or a planetary ball mill (for example, manufactured by Fritsch GmbH) can be suitably used. Of these examples, a grinding mill is preferable because the operation is simple and because it is not necessary to separate balls after the treatment unlike a ball mill.

In the producing method of one or more embodiments of the present disclosure, a bottomed cylindrical vessel equipped with a rotor having an end blade is used, and a predetermined clearance is provided between the end blade and an inner circumference of the vessel. By rotating the rotor, compressive force and shearing force are applied to a mixture containing the positive electrode active material and the oxide-based solid electrolyte. The mechanical coating is conducted in this manner.

The treatment by the mechanical coating method may be a dry process or a wet process. In the case of a wet process, the solvent used is not particularly limited, and water or an organic solvent can be used. As the organic solvent, for example, an alcohol such as ethanol can be used. A timing for adding the solvent in a wet process is not particularly limited, and the oxide-based solid electrolyte may be dispersed in the solvent and used in a slurry state for the mechanical coating method. The concentration of the oxide-based solid electrolyte in the slurry is, for example, 10 to 25 mass %.

A treatment temperature of the mechanical coating may be 5 to 100° C., 8 to 80° C., or 10 to 50° C., and a treatment period may be 5 to 90 minutes, or 10 to 60 minutes. A treatment atmosphere is not particularly limited and can be an inert gas atmosphere or an air atmosphere.

After the mechanical coating, heat treatment is conducted at 300° C. or higher. Through the heat treatment, an adhesion between the positive electrode active material and the oxide-based solid electrolyte improves, and the oxide-based solid electrolyte is prevented from peeling off the positive electrode active material even after repeated charging and discharging, resulting in improvement of the long-term reliability of the battery. When the heat treatment temperature is lower than 300° C., the adhesion between the positive electrode active material and the oxide-based solid electrolyte is insufficient, and thus the solid electrolyte peels off during charging and discharging of the battery, resulting in a decrease in the long-term reliability of the battery. The heat treatment temperature may be 400° C. or higher. When the heat treatment temperature is too high, however, the crystal structure of the oxide-based solid electrolyte changes, and a Li-ion conductivity decreases. Therefore, the battery may not be charged and discharged normally in some cases. The heat treatment temperature may be thus 600° C. or lower, or 500° C. or lower. The heat treatment period may be 30 minutes or longer, or an hour or longer, and the upper limit is not particularly limited and is, for example, three hours or shorter.

### <Positive Electrode Active Material>

The positive electrode active material used in the producing method of one or more embodiments of the present disclosure has an average potential of extraction and insertion of lithium of 4.5 V or more and 5.0 V or less based on Li⁺/Li, namely based on a precipitation potential of Li (sometimes referred to as vs. Li⁺/Li). The potential (hereinafter, also called “voltage”) of the insertion/extraction reaction of lithium ions (vs. Li⁺/Li) can be determined, for example, by measuring charging and discharging characteristics of a half cell using the positive electrode active material for a working electrode and lithium metal for a counter electrode, and reading voltage values at the beginning and the end of a plateau. When there are two plateaus or more, the plateau with the lowest voltage value may be 4.5 V (vs. Li⁺/Li) or more, and the plateau with the highest voltage value may be 5.0 V (vs. Li⁺/Li) or less.

The positive electrode active material in which the insertion/extraction reaction of lithium ions progresses at a potential of 4.5 V or more and 5.0 V or less based on the precipitation potential of Li is not particularly limited, and a substituted lithium manganese compound represented by formula (1) below has been examined and is preferable.

Li₁₊ₓM_{y}Mn_{2-x-y}O₄ (1)

In formula (1) above, x and y satisfy 0≤x≤0.2 and 0<y≤0.8, respectively, and M is at least one kind selected from the group consisting of Al, Mg, Zn, Ni, Co, Fe, Ti, Cu and Cr.

Among compounds of formula (1) above, a Ni-substituted lithium manganese compound in which M is Ni is preferable, and a compound in which x=0, y=0.5 and M=Ni, namely LiNi_{0.5}Mn_{1.5}O₄, is particularly preferable because the effect of stabilizing the charge/discharge cycle is high.

Although a particle size of the positive electrode active material is not particularly limited, when the particle size is too small, the difference with a particle size of the oxide-based solid electrolyte, which will be described below, becomes small, and coating becomes difficult. Thus, a median diameter d₅₀ may be 5 μm or more, 10 μm or more, or 20 μm or more. The median diameter d₅₀ may be 100 μm or less, 80 μm or less, or 50 μm or less. Considering also a thickness range for processing into an electrode, the d₅₀ may be 10 to 50 μm, or 20 to 50 μm.

### <Oxide-Based Solid Electrolyte>

As the solid electrolyte used in one or more embodiments of the present disclosure, an oxide-based solid electrolyte is used considering the chemical stability. The oxide-based solid electrolyte is classified by its crystal structure into antifluorite type, NASICON type, perovskite type, garnet type and the like, and the type is not particularly limited. As the oxide-based solid electrolyte, for example, LATP represented by Li_{1+p+q}(Al,Ga)ₚ(Ti,Ge)₂₋ₚSi_{q}P₃₋ₚO₁₂ (0≤p≤1, 0≤q≤1) can be used, and in particular, Li₁₊ₚAlₚTi₂₋ₚP₃O₁₂ (0≤p≤1) is preferable.

Although a particle size of the oxide-based solid electrolyte is not particularly limited, the particle size is generally smaller than the particle size of the positive electrode active material because the oxide-based solid electrolyte plays a role of coating the surface of the positive electrode active material. A diameter (d_{BET}) determined from a BET specific surface area of the oxide-based solid electrolyte may be 1 to 100 nm, and considering the particle size of the positive electrode active material, may be 1 to 50 nm. It is also preferable that the d_{BET} is 5 nm or more, and the d_{BET} may be 10 nm or more. It is also preferable that the d_{BET} is 45 nm or less, and the d_{BET} may be 40 nm or less. Here, it is not always necessary that the particle size is the above particle size during the granulation of the solid electrolyte, and after preparing with a larger particle size, pulverization may be conducted to reduce to the above particle size. As the pulverization method, a known means such as a ball mill and a bead mill can be used. The diameter (d_{BET}) determined from a BET specific surface area is the particle size determined by the equation d_{BET}=6/(density×BET specific surface area), where a nitrogen adsorption BET specific surface area is determined by a nitrogen adsorption single-point method according to the method defined by JIS-Z8830 (2013).

A ratio of the median diameter d₅₀ of the positive electrode active material to the diameter (d_{BET}) determined from a BET specific surface area of the oxide-based solid electrolyte may be 10000:1 to 100:1, 5000:1 to 300:1, 2000:1 to 500:1, or 1000:1 to 500:1.

A ratio of the oxide-based solid electrolyte (the solid content when used as slurry) to 100 parts by mass of the positive electrode active material may be 0.5 parts by mass or more, 1 part by mass or more, or 2 parts by mass or more, and the ratio may be 10 parts by mass or less, 5 parts by mass or less, or 4 parts by mass or less. The ratio may be 1 part by mass or more and 5 parts by mass or less (that is, the mass ratio of the positive electrode active material to the oxide-based solid electrolyte is 100:1 to 20:1), and it is also preferable that the ratio is 2 parts by mass or more and 4 parts by mass or less (that is, the mass ratio of the positive electrode active material to the oxide-based solid electrolyte is 50:1 to 25:1).

### <Lithium-Ion Secondary Battery>

A lithium-ion secondary battery is composed mainly of a positive electrode, a negative electrode and a non-aqueous electrolyte. The positive electrode is generally produced by applying a positive electrode mixture containing a positive electrode active material, a conductive aid, a binder and the like to a positive electrode current collector, and the negative electrode is generally produced by applying a negative electrode mixture containing a negative electrode active material, a conductive aid, a binder and the like to a negative electrode current collector. The coated positive electrode active material obtained by the producing method of one or more embodiments is suitably used as the positive electrode active material of a lithium-ion secondary battery, and specifically, a positive electrode can be produced by applying a positive electrode mixture containing the coated positive electrode active material obtained by the producing method of one or more embodiments to a positive electrode current collector. After applying the positive electrode mixture to the positive electrode current collector and after applying the negative electrode mixture to the negative electrode current collector, the collectors may be dried at around 100 to 200° C.

To a structure of the lithium-ion secondary battery using the coated positive electrode active material, materials used other than the coated positive electrode active material and an apparatus and conditions for producing the lithium-ion secondary battery, those which are conventionally known can be applied, without any particular limitation.

### <Negative Electrode Active Material>

As a negative electrode active material, lithium titanate may be used because lithium does not easily precipitate and because the safety improves, as described above. Among lithium titanate, lithium titanate having a spinel structure is particularly preferable because a swelling and shrinkage of the active material during the insertion/extraction reaction of lithium ions are small. The lithium titanate may contain a small amount of an element other than lithium and titanium such as Nb.

### <Conductive Aid>

A conductive aid is not particularly limited and may be a carbon material. Examples include natural graphite, artificial graphite, vapor grown carbon fibers, carbon nanotubes, acetylene black, Ketjen black, furnace black and the like. A kind of the carbon materials or two or more kinds thereof may be used. An amount of the conductive aid contained in the positive electrode, based on 100 parts by weight of the positive electrode active material, may be 1 part by weight or more and 30 parts by weight or less, or 2 parts by weight or more and 15 parts by weight or less. In the range, the conductivity of the positive electrode is secured. Moreover, an adhesion to the binder described below is maintained, and sufficient adhesion to a current collector can be obtained. The amount of the conductive aid contained in the negative electrode, based on 100 parts by weight of the negative electrode active material, may be 1 part by weight or more and 30 parts by weight or less, or 2 parts by weight or more and 15 parts by weight or less.

### <Binder>

A binder is not particularly limited, and is for example, at least one kind selected from the group consisting of polyvinylidene fluoride (PVdF), polytetrafluoroethylene (PTFE), styrene-butadiene rubber, polyimide and derivatives thereof can be used for both of the positive electrode and the negative electrode. The binder may be dissolved or dispersed in a non-aqueous solvent or in water because the positive electrode and the negative electrode are easily produced. The non-aqueous solvent is not particularly limited, and examples include N-methyl-2-pyrrolidone (NMP), dimethylformamide, dimethylacetamide, methyl ethyl ketone, methyl acetate, ethyl acetate, tetrahydrofuran and the like. A dispersing agent or a thickener may be added thereto. An amount of the binder contained in the positive electrode of one or more embodiments, based on 100 parts by weight of the positive electrode active material, may be 1 part by weight or more and 30 parts by weight or less, or 2 parts by weight or more and 15 parts by weight or less. In the range, an adhesion between the positive electrode active material and the conductive aid material is maintained, and sufficient adhesion to the current collector can be obtained. An amount of the binder contained in the negative electrode, based on 100 parts by weight of the negative electrode active material, may be 1 part by weight or more and 30 parts by weight or less, or 2 parts by weight or more and 15 parts by weight or less.

### <Current Collectors>

Both of a positive electrode current collector and a negative electrode current collector may be aluminum or an aluminum alloy. Aluminum or an aluminum alloy is stable in an atmospheres of reactions at the positive electrode and the negative electrode and thus is not particularly limited, and high purity aluminum represented by those of JIS standards 1030, 1050, 1085, 1N90, 1N99 and the like is preferable. Thicknesses of the current collectors are not particularly limited and may be 10 μm or more and 100 μm or less. In the range, a balance in a handling property during a production of the battery, costs and characteristics of the obtained battery can be easily kept. Here, for the current collectors, those obtained by coating a surface of a metal other than aluminum (copper, SUS, nickel, titanium and alloys thereof) with a metal which does not react at potentials of the positive electrode and the negative electrode can also be used.

### <Non-Aqueous Electrolyte>

A non-aqueous electrolyte is not particularly limited, and a non-aqueous electrolytic solution obtained by dissolving a solute in a non-aqueous solvent, a gel electrolyte obtained by impregnating a polymer with a non-aqueous electrolytic solution obtained by dissolving a solute in a non-aqueous solvent or the like can be used.

As the non-aqueous solvent, a cyclic aprotic solvent and/or an open-chain aprotic solvent may be contained. Examples of the cyclic aprotic solvent include cyclic carbonates, cyclic esters, cyclic sulfones, cyclic ethers and the like. As the open-chain aprotic solvent, a solvent which is generally used as a solvent of a non-aqueous electrolyte such as open-chain carbonates, open-chain carboxylate esters, open-chain ethers and acetonitrile may be used. More specifically, dimethyl carbonate, methyl ethyl carbonate, diethyl carbonate, dipropyl carbonate, methyl propyl carbonate, ethylene carbonate, propylene carbonate, butylene carbonate, γ-butyllactone, 1,2-dimethoxyethane, sulfolane, dioxolane, methyl propionate and the like can be used. Although a kind of the solvents may be used or two or more kinds thereof may be mixed and used, a solvent obtained by mixing two or more kinds thereof may be used because of the easy dissolution of the solute described below and the high conductivity of lithium ions.

When two or more kinds are mixed, because of a high stability at a high temperature and a high lithium conductivity at a low temperature, a mixture of a kind or more of open-chain carbonates exemplified by dimethyl carbonate, methyl ethyl carbonate, diethyl carbonate, dipropyl carbonate and methyl propyl carbonate and a kind or more of cyclic compounds exemplified by ethylene carbonate, propylene carbonate, butylene carbonate and γ-butyllactone is preferable, and a mixture of a kind or more of open-chain carbonates exemplified by dimethyl carbonate, methyl ethyl carbonate and diethyl carbonate and a kind or more of cyclic carbonates exemplified by ethylene carbonate, propylene carbonate and butylene carbonate is particularly preferable.

The solute is not particularly limited, and for example, LiClO₄, LiBF₄, LiPF₆, LiAsF₆, LiCF₃SO₃, LiBOB (Lithium Bis (Oxalato) Borate), LiN(SO₂CF₃)₂ and the like easily dissolve in a solvent and are thus preferable. A concentration of the solute contained in the non-aqueous electrolyte may be 0.5 mol/L or more and 2.0 mol/L or less. The desired lithium-ion conductivity may not be exhibited with a concentration lower than 0.5 mol/L, while the solute may not dissolve completely anymore when the concentration is higher than 2.0 mol/L.

An amount of the non-aqueous electrolyte used for the lithium-ion secondary battery of one or more embodiments of the present disclosure is not particularly limited and may be 0.1 mL or more per 1 Ah battery capacity. With the amount, a lithium-ion conduction accompanying an electrode reaction can be secured, and the desired battery performance is exhibited.

The non-aqueous electrolyte may be added to the positive electrode, the negative electrode and the separator in advance or added after placing the separator between the positive electrode side and the negative electrode side and winding or laminating the components.

The lithium-ion secondary battery usually further includes a separator and an external material in addition to the above components.

### (Separator)

A separator is placed between the positive electrode and the negative electrode, and may have an insulating property and a structure which can contain the non-aqueous electrolyte described below. Examples include woven clothes, nonwoven clothes, microporous membranes and the like of nylon, cellulose, polysulfone, polyethylene, polypropylene, polybutene, polyacrylonitrile, polyimide, polyamide, polyethylene terephthalate and a composite of two or more kinds thereof. From the viewpoint of an excellent stability of a cycle property, nonwoven clothes of nylon, cellulose, polysulfone, polyethylene, polypropylene, polybutene, polyacrylonitrile, polyimide, polyamide, polyethylene terephthalate and a composite of two or more kinds thereof are preferable.

The separator may contain a plasticizer, an antioxidant or a flame retardant or may be coated with a metal oxide or the like. The thickness of the separator is not particularly limited and may be 10 μm or more and 100 μm or less. In the range, an increase in a resistance of the battery can be prevented while a short circuit of the positive electrode and the negative electrode is prevented. In view of an economical efficiency and handling, the thickness may be 15 μm or more and 50 μm or less.

A porosity of the separator may be 30% or more and 90% or less. When the porosity is less than 30%, a diffusivity of lithium ions decreases, and thus a cycle property deteriorates considerably. On the other hand, when the porosity is higher than 90%, an unevenness of the electrodes penetrates the separator, and a possibility of a short circuit becomes extremely high. In view of a balance of securing the diffusivity of lithium ions and preventing the short circuit, the porosity may be 35% or more and 85% or less, or 40% or more and 80% or less because the balance is particularly excellent.

### (External Material)

An external material is a member which encloses a laminate obtained by laminating or winding the positive electrode, the negative electrode and the separator alternately and terminals that connect the laminate electrically. As the external material, a composite film of a metal foil with a thermoplastic resin layer for heat sealing; a metal layer formed by evaporation or sputtering; or a metal can of square-shaped, oval-shaped, cylindrical-shaped, coin-shaped, button-shaped or sheet-shaped is suitably used.

### EXAMPLES

The one or more embodiments are more specifically explained in the Examples. The one or more embodiments are not restricted by the Examples below, and can be of course carried out with appropriate changes in the scope which meets the purposes described above and below, which are all included in the technical scope of the disclosure.

The batteries obtained in the Examples and the Comparative Examples below were evaluated by the following methods.

### (Amounts of Gas Generation)

The amounts of gas generation of the lithium-ion secondary batteries before and after the evaluation of the cycle property in the Examples and the Comparative Examples were evaluated by the Archimedes' method, namely using the buoyancies of the lithium-ion secondary batteries. The evaluation was conducted as follows.

First, the weight of a lithium-ion secondary battery was measured with an electronic scale. Next, the weight in water was measured using a densimeter (manufactured by Alfa Mirage Co., Ltd., product No. MDS-3000), and the buoyancy was calculated from the difference of the weights. By dividing the buoyancy by the density of water (1.0 g/cm³), the volume of the lithium-ion secondary battery was calculated. By comparing the volume after aging and the volume after the evaluation of the cycle property, the amount of the generated gas was calculated. The amount of gas generation was determined to be good when the amount was less than 20 ml. The amount of gas generation may be 15 ml or less.

### (Evaluation of Cycle Property of Lithium-Ion Secondary Batteries)

The lithium-ion secondary batteries produced in the Examples or the Comparative Examples were connected to a charging and discharging apparatus (HJ 1005SD8, manufactured by Hokuto Denko Corporation), and cycle operation was conducted. Constant-current charging was conducted in an environment at 60° C. at a current value equivalent to 1.0 C until the battery voltage reached the end voltage of 3.4 V, and charging was stopped. Then, constant-current discharging was conducted at a current value equivalent to 1.0 C, and discharging was stopped when the battery voltage reached 2.5 V. This was regarded as one cycle, and charging and discharging were repeated. The stability of the cycle property was evaluated with the discharge capacity retention rate (%) which is the discharge capacity of the 500th cycle based on the discharge capacity of the first cycle regarded as 100. The cycle property was determined to be good when the discharge capacity retention rate of the 500th cycle was 80% or more and to be poor when the retention rate was less than 80%.

### Synthesis Example 1: Production of Solid Electrolyte

As a solid electrolyte, Li_{1.3}Al_{0.3}Ti_{1.7}(PO₄)₃ (also called LATP below) was prepared. Certain amounts of Li₂CO₃, AlPO₄, TiO₂ and NH₄H₂PO₄ as starting materials and ethanol as a solvent were mixed, and planetary ball mill treatment was conducted using zirconia balls having a diameter of 3 mm at 150 G for an hour. The zirconia balls were removed from the mixture after the treatment using a sieve, and then ethanol was removed by drying at 120° C. Then, treatment was conducted at 800° C. for two hours, and LATP powder was thus obtained.

A certain amount of ethanol as a solvent was mixed into the obtained LATP powder, and planetary ball mill treatment was conducted using zirconia balls having a diameter of 0.5 mm at 150 G for an hour. The zirconia balls were removed from the mixture after the treatment using a sieve, and ethanol was removed by drying at 120° C. By the procedures, fine LATP powder having a d_{BET} of 23 nm was obtained. Next, the fine LATP powder and ethanol were mixed, and a slurry in which 16.4% by weight of the fine LATP powder was dispersed in ethanol was thus obtained.

### Example 1

### (i) Production of Positive Electrode

As the active material of the positive electrode, lithium nickel manganate (LiNi_{0.5}Mn_{1.5}O₄, also called LNMO below) of spinel type having a median diameter of 20 μm was used.

LNMO in an amount of 40 g was fed into a grinding mill (manufactured by Hosokawa Micron Corporation, Nobilta), and 6.1 g of the slurry in which the fine LATP powder was dispersed in ethanol obtained in Synthesis Example lwas fed in two portions, while the grinding mill was rotated at 2600 rpm with a clearance of 0.6 mm and a rotor load power of 1.5 kW. Then, treatment was conducted at room temperature for 10 minutes in an air atmosphere while the rotor rotation speed was kept in the range of 2600 to 3000 rpm, and LNMO whose surface was coated with LATP was obtained. The obtained surface-coated LNMO was heat-treated at 500° C. for an hour.

A mixture containing the obtained surface-coated LNMO, acetylene black as a conductive aid and polyvinylidene fluoride (PVdF) as a binder at solid concentrations of 90 parts by weight, 6 parts by weight and 4 parts by weight, respectively, was dispersed in N-methyl-2-pyrrolidone (NMP), and a slurry was thus produced. The binder used here was obtained by preparing an N-methyl-2-pyrrolidone (NMP) solution having a solid concentration of 5% by weight, and the viscosity was adjusted by further adding NMP so that the application described below would become easy.

The slurry was applied to an aluminum foil of 20 μm and then dried in an oven at 120° C. After conducting this operation for both sides of the aluminum foil, a positive electrode was produced by further vacuum-drying at 170° C.

### (ii) Production of Negative Electrode

As the negative electrode active material, lithium titanate (Li₄Ti₅O₁₂, also called LTO below) of spinel type was used. A mixture containing the LTO, acetylene black as a conductive aid material and PVdF as a binder at solid concentrations of 100 parts by weight, 5 parts by weight and 5 parts by weight, respectively, was dispersed in N-methyl-2-pyrrolidone (NMP), and a slurry was thus produced. The binder used here was obtained by preparing an NMP solution having a solid concentration of 5% by weight, and the viscosity was adjusted by further adding NMP so that the application described below would become easy.

The slurry was applied to an aluminum foil of 20 μm and then dried in an oven at 120° C. After conducting this operation for both sides of the aluminum foil, a negative electrode was produced by further vacuum-drying at 170° C.

(iii) Production of Lithium-Ion Secondary Battery

Using the positive electrode and the negative electrode produced in (i) and (ii) above and a separator made of polypropylene of 20 μm, a battery was produced by the following procedures. First, the positive electrode and the negative electrode were dried under reduced pressure at 80° C. for 12 hours. Next, 15 positive electrode pieces and 16 negative electrode pieces were laminated in the order of negative electrode/separator/positive electrode. The outermost layers were both the separator. Then, aluminum tabs were attached by vibration welding to the positive electrode and the negative electrode at both ends.

Two pieces of aluminum laminate film as the external material were prepared, and after forming a hollow for a battery part and a follow for a gas collection part by pressing, the electrode laminate was inserted. The periphery was heat-sealed at 180° C. for seven seconds, leaving a space for injecting a non-aqueous electrolyte. A non-aqueous electrolyte obtained by dissolving LiPF₆ at a proportion resulting in 1 mol/L in a solvent of a mixture was introduced from the unsealed part. The mixture was obtained by mixing ethylene carbonate, propylene carbonate and ethyl methyl carbonate at a ratio by volume of ethylene carbonate/propylene carbonate/ethyl methyl carbonate=15/15/70. Then, the unsealed part was heat-sealed at 180° C. for seven seconds while the pressure was decreased. The obtained battery was charged at a constant current of a current value equivalent to 0.2 C until the battery voltage reached the end voltage of 3.4 V, and charging was stopped. Then, the battery was left still in an environment at 60° C. for 24 hours. Constant-current discharging was conducted at a current value equivalent to 0.2 C, and discharging was stopped when the battery voltage reached 2.5 V. After stopping discharging, the gas gathered in the gas collection part was removed, and the battery was sealed again. Through the above operations, a lithium-ion secondary battery for evaluation was produced.

### Example 2

A lithium-ion secondary battery for evaluation was produced by the same operations as those in Example 1 except that surface-coated LNMO obtained by heat treatment at 400° C. instead of 500° C. after coating LNMO with LATP was used for producing the positive electrode.

### Example 3

A lithium-ion secondary battery for evaluation was produced by the same operations as those in Example 1 except that surface-coated LNMO obtained by heat treatment at 300° C. instead of 500° C. after coating LNMO with LATP was used for producing the positive electrode.

### Comparative Example 1

A lithium-ion secondary battery for evaluation was produced by the same operations as those in Example 1 except that surface-coated LNMO obtained by heat treatment at 200° C. instead of 500° C. after coating LNMO with LATP was used for producing the positive electrode.

### Comparative Example 2

A lithium-ion secondary battery for evaluation was produced by the same operations as those in Example 1 except that surface-coated LNMO obtained without the heat treatment after coating LNMO with LATP was used for producing the positive electrode.

### Comparative Example 3

The fine LATP powder obtained in Synthesis Example 1 was dispersed in ethanol, and while stirring, LNMO was added at a weight ratio to the fine LATP powder of 10, followed by stirring for an hour. Subsequently, ethanol was removed by reducing the pressure, and then ethanol was further removed by heating at 120° C. LNMO with a surface coated with LATP was thus obtained. The obtained surface-coated LNMO was heat-treated at 400° C. for an hour. A lithium-ion secondary battery for evaluation was produced by the same operations as those in Example 1 except that the positive electrode was prepared using this surface-coated LNMO.

### Comparative Example 4

A lithium-ion secondary battery for evaluation was produced by the same operations as those in Example 1 except that LNMO obtained without surface coating was used.

The evaluation results of the Examples and the Comparative Examples are shown in Table 1.

TABLE 1

| | Production method | | | |
|---|---|---|---|---|
| | | Heat | Amount of | |
| | | Treatment | Gas | Cycle Property |
| | Coating | Temperature | Generation | (Capacity |
| | Method | (° C.) | (ml) | Retention Rate %) |
| Example 1 | mechanical | 500 | 13 | 82 |
| | coating | | | |
| Example 2 | mechanical | 400 | 12 | 87 |
| | coating | | | |
| Example 3 | mechanical | 300 | 14 | 84 |
| | coating | | | |
| Comparative | mechanical | 200 | 20 | 75 |
| Example 1 | coating | | | |
| Comparative | mechanical | Not | 25 | 70 |
| Example 2 | coating | conducted | | |
| Comparative | solution | 400 | 35 | 70 |
| Example 3 | applying | | | |
| Comparative | Not conducted | | 40 | 60 |
| Example 4 | | | | |

The lithium-ion secondary batteries of Examples 1 to 3 resulted in low amounts of gas generation in the evaluation of the cycle property and high capacity retention rates.

On the other hand, Comparative Example 1, in which the heat treatment temperature after coating with LATP was low, and Comparative Example 2, in which the heat treatment was not conducted, resulted in high amounts of gas generation and low capacity retention rates. It is believed that this is because LATP peeled off LNMO during the evaluation of the cycle property due to the insufficient adhesion between LNMO and LATP and thus there were more contact points between the non-aqueous electrolyte and LNMO.

Furthermore, Comparative Example 3 resulted in a further higher amount of gas generation than those of Comparative Examples 1 and 2 and a lower capacity retention rate. It is believed that this is because LATP did not exist uniformly on the surface of LNMO and thus there were more contact points between the non-aqueous electrolyte and LNMO since the surface was coated in Comparative Example 3 by a means of evaporating the solvent from the mixed solution of LATP and LNMO instead of mechanical coating. Moreover, Comparative Example 4, in which LNMO without surface coating was used, showed the worst results with respect to the amount of gas generation and the capacity retention rate.

The above results show that a lithium-ion secondary battery using a positive electrode active material obtained by coating the surface with an oxide-based solid electrolyte by a mechanical coating method and conducting heat treatment in an appropriate temperature range has a low amount of gas generation even after charging and discharging at a high potential and has an excellent cycle property.

The coated positive electrode active material obtained by the manufacturing method of the invention is suitably used as a positive electrode active material of a lithium-ion secondary battery.

Although the disclosure has been described with respect to only a limited number of embodiments, those skilled in the art, having benefit of this disclosure, will appreciate that various other embodiments may be devised without departing from the scope of the present disclosure.

1. A method for producing a coated positive electrode active material for a lithium-ion secondary battery, the method comprising:
coating a surface of a positive electrode active material with an oxide-based solid electrolyte by a mechanical coating method and then
conducting heat treatment at 300° C. or higher,
wherein the positive electrode active material has an average potential of extraction and insertion of lithium of 4.5V or more and 5.0V or less based on Li⁺/Li,
wherein a diameter d_{BET} determined from a BET specific surface area of the oxide-based solid electrolyte is 1 to 100 nm, and
wherein a ratio of a median diameter of the positive electrode active material to the diameter d_{BET} determined from the BET specific surface area of the oxide-based solid electrolyte is 10000:1 to 100:1.

2. The method according to claim 1, wherein the mechanical coating is conducted with a grinding mill.

3. The method according to claim 1, wherein the positive electrode active material is a substituted lithium manganese compound represented by formula (1) below:
Li₁₊ₓM_{y}Mn_{2-x-y}O₄ (1)
wherein in formula (1), x and y satisfy 0≤x≤0.2 and 0<y≤0.8, respectively, and M is at least one kind selected from the group consisting of Al, Mg, Zn, Ni, Co, Fe, Ti, Cu and Cr.

4. A method for producing a lithium-ion secondary battery having a positive electrode, a negative electrode and a non-aqueous electrolyte, the method comprising:
a step of applying a positive electrode mixture containing the coated positive electrode active material obtained by the method according to claim 1 to a positive electrode current collector.

5. A lithium-ion secondary battery obtained by the method according to claim 4.

6. A method for producing a lithium-ion secondary battery having a positive electrode, a negative electrode and a non-aqueous electrolyte, the method comprising:
a step of applying a positive electrode mixture containing the coated positive electrode active material obtained by the method according to claim 3 to a positive electrode current collector.
